(19) United States
(12) Patent Application Publication
(10) Pub. No.: US 2015/0242905 A1
(43) Pub. Date: Aug. 27, 2015

(54) SYSTEM AND METHOD FOR IMPROVED PERSONALIZATION USING MOBILE TECHNOLOGY

(71) Applicant: Sailthru, Inc., New York, NY (US)

(72) Inventors: Neil James Capel, New York, NY (US); Ian Bradford White, Brooklyn, NY (US); Nick Gundry, New York, NY (US)

(21) Appl. No.: 14/634,506

(22) Filed: Feb. 27, 2015

Related U.S. Application Data
(63) Continuation of application No. 14/523,513, filed on Oct. 24, 2014.
(60) Provisional application No. 61/945,711, filed on Feb. 27, 2014.

(51) Int. Cl. G06Q 30/02; G06Q 50/00

(52) U.S. Cl. CPC G06Q 30/0269; G06Q 30/0255; G06Q 50/01

(57) ABSTRACT

Information is managed for a group of computing devices associated with a plurality of users and contextual messages are provided to at least one device in the group. The group is defined by code executing in at least one processor, and at least one criteria selection representing a respective type of activity associated with users of the group of computing devices is processed. Usage information associated with each respective user is processed by comparing the usage information with the at least one criteria selection. In accordance with the processed usage information, the at least one of the computing devices in the group is identified, and a contextual message is generated in accordance with at least one of the criteria selection. The contextual message is transmitted to each of the at least one computing device in the group. This can occur in one or more implementations of the present application.

### CROSS REFERENCE TO RELATED APPLICATIONS

This application is a continuation and is based on U.S. patent application Ser. No. 14/523,513, filed on Oct. 24, 2014, and further is based on and claims priority to U.S. Provisional Patent Application Ser. No. 61/945,711, filed Feb. 27, 2014, the entire contents of both of which are=hereby incorporated by reference as if set forth in the respective entireties herein.

### FIELD

The present invention relates generally to networking and, more particularly, to providing personalized service.

### BACKGROUND OF THE INVENTION

Various providers of products and services (e.g., merchants) continue to seek new ways to engage customers. Push notifications, for example, enable a merchant to send a message to a group of users at some specific time, for example to the users' mobile devices. When received, the devices create an alert, and the next time the users activate their devices, the notification is visible. The users then decide the next step. Moreover, many such alerts are generic and not of interest, and detract users' attention.

Unfortunately, it is recognized that too often users simply take no further action and/or forget about the message they just received.

### SUMMARY OF THE INVENTION

The present application addresses these and other concerns. In one or more implementations, a system and/or method for managing information is provided for a group of computing devices associated with a plurality of users and for providing contextual messages to at least one of the computing devices in the group. The group is defined by code executing in at least one processor, and at least one criteria selection representing a respective type of activity associated with users of the group of computing devices is processed. Further, usage information associated with each respective user is processed by comparing the usage information with the at least one criteria selection. In accordance with the processed usage information, the at least one of the computing devices in the group is identified and a contextual message is generated in accordance with at least one of the criteria selection. The message is transmitted to each of the at least one computing device in the group.

Other features and advantages of the present application will become apparent from the following description of the invention that refers to the accompanying drawings.

### BRIEF DESCRIPTION OF DRAWINGS/FIGURES

Further aspects of the present disclosure will be more readily appreciated upon review of the detailed description of its various embodiments, described below, when taken in conjunction with the accompanying drawings, of which:

FIG. 1 is a block diagram that illustrates an example arrangement of hardware devices and associated flow of information, in connection with an example implementation of the present application;

FIG. 2 is a block diagram that illustrates functional elements of one or more of a data processing apparatus and/or other computing device in accordance with one or more implementations of the present application;

FIG. 3 is a block diagram representing a plurality of modules that provide functionality, such as shown and described herein;

FIGS. 4A and 4B illustrate example data entry screen displays provided in accordance with one or more implementations of the present application; and

FIGS. 5A-6 are flow diagrams illustrating steps associated with example implementations of the present application.

### DETAILED DESCRIPTION

By way of overview and introduction, systems and methods are provided herein to engage user computing devices to provide notifications of opportunities in the marketplace. In addition, system and methods are provided to effectuate transactions, such as small purchases of products and/or services. Moreover, user computing devices can be engaged as a function of one or more tokens stored on a client object, such as a software application, that is installed on a respective computing device. For example, product information, special offers or the like can be provided substantially automatically in response to a determination that a user computing device is configured to include the token. Engaging user computing devices can include determining that a consumer who is associated with a respective user computing device satisfies one or more criteria, such as relating to a number of purchases made by the user, the amount of time since the user made a purchase or an inquiry relating to a product or service, or other definable criteria. Thus, information such as future purchasing habits can be based on previous purchases, browsing history or other consumer habit information for defining criteria in connection with a custom audience, such as in connection with future advertising. Information that may be accessible to a data processing apparatus, including for enabling or otherwise providing the features shown herein, can include information associated with merchant accounts, e.g., history of purchased products/services, current inventory, contact information, location information, specials, or other information associated with a merchant. In addition to information relating to merchants, information associated with user accounts is accessible, such as information associated with previous purchases, user computing device and software application installation information, and other user account information, such as relating to user contact information.

In one or more implementations, the present application provides for access to one or more databases to provide access and process information in order to predict future purchases by one or more users. The database(s) accessed in accordance with the present application can include merchant information representing, for example, name and contact information, including location information of merchants. Additionally, the database(s) include information associated with consumers, and can store information on particular consumers who have installed a respective mobile app on a mobile computing device (e.g., a smartphone) that includes a token or other mechanism that is suitable for identifying a computing device associated with a user.

In one or more implementations, a prompt can be provided to computing device associated with a user representing an option for the user to purchase a product/service. For example, the option may include a special discount offer, coupon and/or access to one or more items that are in high demand and difficult to obtain. Options can be provided to receive input from the user, such as in response to a prompt to purchase a product/service.

Thus, the present application provides personalized services that can be specific to individual purchasing habits, and that provides for safe and convenient ordering of products and services. Various forms of messaging are supported for custom-defined audience groups that satisfy one or more criteria. A message can automatically appear in a graphical user interface and a menu on the user's computing device, such as a mobile app with other suitable communication platforms, such as text messaging, telephonic implementations or the like.

In one or more implementations of systems and methods disclosed herein, information can be accessed and/or received, including as a function of a token included in an application installed on a user's computing device. The information can represent the computing device, the user, and/or activity associated therewith. For example, detailed information regarding a user's purchasing and browsing history can be accessed and used to engage the user in meaningful ways. Such information can be obtained or accessed from one or more databases that are accessible over a data communication network or locally. For example, information stored in one or more user profiles can be accessed to garner additional information associated with the user of the computing device. Furthermore, information can be obtained as a function of one or more email campaigns, such as shown and described in co-pending and commonly assigned U.S. patent application Ser. No. 14/262,361 and filed Apr. 25, 2014, the entirety of which is incorporated by reference as if expressly set forth herein. Alternatively (or in addition), information can be obtained as a function of one or more Push Notifications. The information can be used to generate a recommendation or other course of action, and can be delivered to a consumer or party associated with a merchant.

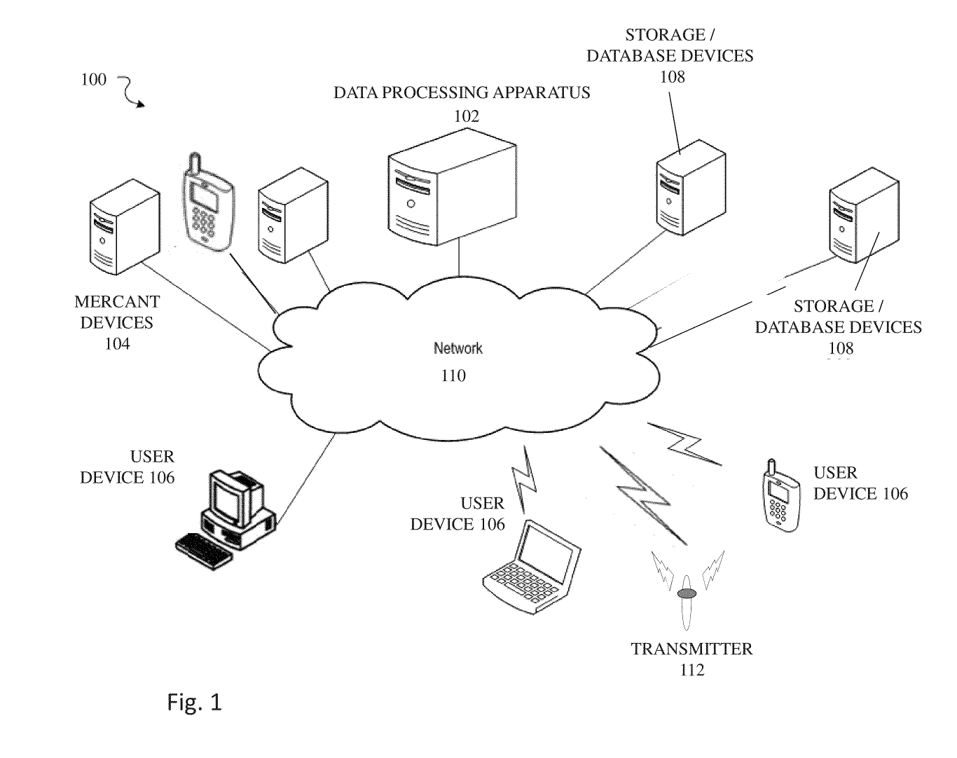

Referring to the drawings, in which like reference numerals refer to like elements, FIG. 1 is a block diagram illustrating an example implementation of the present application and that represents an association of a plurality of devices and the flow of information associated with the devices. In the example shown in FIG. 1, various computing devices 102, 104, 106 and 108 are shown, each capable of executing desktop and/or mobile computing device web browser application(s) including INTERNET EXPLORER, CHROME, FIREFOX, and other (e.g., SAFARI, OPERA). In addition to standard web browser application functionality, user information can be gathered via Push Notifications, and information can be retrieved from a computing device using a “REST” interface. Various mobile devices running different operating systems are shown, including IOS, ANDROID and other (e.g., PALM, WINDOWS or other mobile device operating system).

In the example shown in FIG. 1, data processing apparatus 102 is operatively coupled to the computing devices 104, 106 and 108. Devices 104, 106 and 108 can be respectively operated by one or more merchants (merchant computing devices 104) and consumers (user computing devices 106). Merchants can include, for example, retail providers of products and/or services, and consumers can include past and/or future purchasers thereof. Storage/database devices 108 can include one or more computing devices that are operable to store various information including, for example, personal or identifying information about a user, information identifying a respective computing device and/or software operating thereon, user activity (e.g., browsing history, purchase history, information about a respective social network, social actions or activities, profession, preferences or a current location), or the like. In the example implementation illustrated in FIG. 1 the designation of storage/database devices 108 to appear as separate and distinct from merchant computing devices 104 and user computing devices 106. It is to be understood that storage/database devices 108 do not have to be separate from devices 102, 104 or 106 and that storage/database devices 108 can be the same as or otherwise comprise a subset of devices 102, 104 and/or 106.

In addition, certain data can be treated in one or more ways before it is stored or used, so that personally identifiable information is not displayed. For example, a person's identification number can be used to retrieve detailed information about a user, and which can be transmitted to a merchant to enable the merchant to provide specialized service. The merchant (or the specific employee or agent of the merchant who interacts with the user) may not be provided with personally identifiable information about the user. In this way, a user's anonymity can be preserved, for example to maintain expectations of anonymity of typical shoppers in public retail spaces. Also illustrated in FIG. 1 is a network 110, which can be configured as a local area network (LAN), wide area network (WAN), Peer-to-Peer network (“P2P”), Multi-Peer network, the Internet, one or more telephony networks or a combination thereof, that is operable to connect data processing apparatus 102, merchant devices 104, user devices 106 and other storage/database devices 108. Though many of the examples and implementations shown and described herein relate to product and/or service recommendations, many other forms of content can be provided and/or delivered by system 100.

Continuing with reference to FIG. 1, transmitter 112 is shown that is configured to transmit wirelessly a signal that can be received by a computing device, such as mobile user computing device 106.

Additional functionality provided herein and in accordance with one or more of computing devices 102, 104 and 108 and transmitter 112 is shown and described in commonly assigned and co-pending U.S. patent application Ser. No. 14/304,628, filed on Jun. 13, 2014 and entitled SYSTEM AND METHOD FOR IMPROVED PERSONALIZATION USING BEACON TECHNOLOGY, the entire contents of which is hereby incorporated by reference as if set forth in its entirety herein.

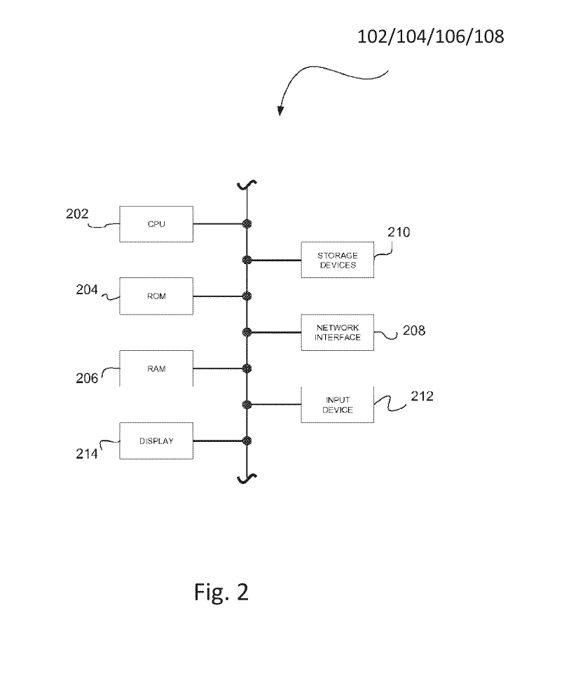

FIG. 2 is a block diagram that illustrates functional elements of one or more of data processing apparatus 102 or computing device (104, 106, 108) and preferably include one or more central processing units (CPU) 202 used to execute software code in order to control operations, including of data processing apparatus 102, read only memory (ROM) 204, random access memory (RAM) 206, one or more network interfaces 208 to transmit and receive data to and from other computing devices across a communication network, storage devices 210 such as a hard disk drive, solid state drive, floppy disk drive, tape drive, CD-ROM or DVD drive for storing program code, databases and application code, one or more input devices 212 such as a keyboard, mouse, track ball and the like, and a display 214.

The various components of devices 102, 104, 106 and/or 108 need not be physically contained within the same chassis or even located in a single location. For example, storage device 210 may be located at a site which is remote from the remaining elements of computing devices 102, 104, 106 and/or 108, and may even be connected to CPU 202 across communication network 106 via network interface 208.

The functional elements shown in FIG. 2 (designated by reference numbers 202-214) are preferably the same categories of functional elements preferably present in computing device 104, 106 and/or 108. However, not all elements need be present, for example, storage devices in the case of PDAs, and the capacities of the various elements are arranged to accommodate expected user demand. For example, CPU 202 in computing device 104, 106 and/or 108 can be of a smaller capacity than CPU 202 as present in data processing apparatus 102. Similarly, it is likely that data processing apparatus 102 will include storage devices 210 of a much higher capacity than storage devices 210 present in computing device 104, 106 and/or 108. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, OBJECTIVE C, ANDROID, TORR and various web application development environments.

As used herein, references to displaying data on computing device 104, 106 and/or 108 refer to the process of communicating data to the computing device 104, 106 and/or 108 across communication network 106 and processing the data such that the data can be viewed on the user computing device 104, 106 and/or 108 display 214 using a web browser, custom application or the like. The display screens on computing device 104, 106 and/or 108 present areas within system 100 such that a user can proceed from area to area within the system 100 by selecting a desired link. Therefore, each user's experience with system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of system 100.

Although the present application is described by way of example herein in terms of a web-based system using web browsers, custom applications and a web site server (data processing apparatus 102), and with mobile computing devices, system 100 is not limited to that particular configuration. It is contemplated that system 100 can be arranged such that computing device 104, 106 and/or 108 can communicate with, and display data received from, data processing apparatus 102 using any known communication and display method, for example, using a non-Internet browser Windows viewer coupled with a local area network protocol such as the Internetwork Packet Exchange (IPX). It is further contemplated that any suitable operating system can be used on computing device 104, 106 and/or 108, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, OSX, LINUX, IOS, ANDROID and any suitable PDA or palm computer operating system.

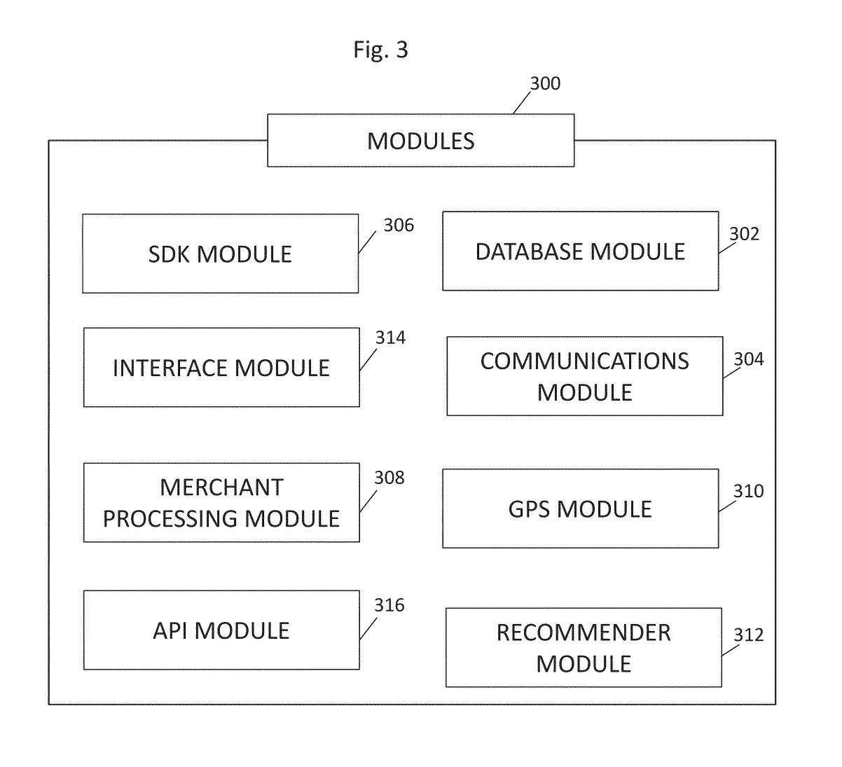

FIG. 3 is a block diagram representing a plurality of modules 300 that provide functionality, such as shown and described herein. Depending upon a respective implementation, the modules 300 can be provided via a single computing device, such as data processing apparatus 102, or can be distributed via a plurality of computing devices, such as computing devices 102, 104, 106 and/or 108. Moreover, one module can be provided via a single computing device (102, 104, 106 or 108), or can be distributed across a plurality of computing devices.

Included in FIG. 3 is database module 302 that can store various information, including that relate to one or more of: identifiers transmitted by respective transmitters 112; respective software applications configured to provide graphical user interfaces, manage information and provide features shown and described herein and operable with user computing devices 106; user profiles that are associated with each of a plurality of users of user computing devices 106; user purchasing history, such as via web browser history and representational state transfer (“REST”), that can be associated with at least one web page accessed by at least one of the user devices 106; and inventory associated with at least one product and/or service respectively associated with each of a plurality of merchants.

Continuing with reference to FIG. 3, communications module 304 can include hardware and/or software components and be configured to interface with at least one of the respective merchant computing devices 104 and/or user computing devices 106 in response to the user computing device 106 transmitting instructions (e.g., in response to prompts) associated with purchasing a product/service.

Also illustrated in FIG. 3 is SDK module 306 that is configured to provide tools (e.g., class files, packages or other program resources) that enable software developers to implement features such as shown and described herein. Using the SDK module 306, developers can customize software to operate on merchant computing devices 104 and/or user computing devices 106 and configure the devices to receive and/or send information from one or more data processing apparatuses 102 detect, as well as to develop customized software applications (e.g., mobile apps) to operate on one or more devices 104 and 106. The SDK module 306 can be configured to supply appropriate content to a computing device 104 and 106.

Continuing with reference to FIG. 3, merchant processing module 308 is configured to interface with one or more merchant-based hardware and software systems, including merchant computing devices 104 and databases on storage devices 108, as well as computing devices 106 and data processing apparatus 102. Merchant processing module 308 can include one or more software applications that configure computing devices 104. In one or more implementations, an API Key for merchants can be installed in the software application(s), which can be stored securely, for example, via an operating system (e.g., iOS) level storage.

Continuing with reference to FIG. 3, GPS module 310 can be usable, for example, to identify locations and trajectories of respective user computing devices 106 and for data processing apparatus 102 and/or merchant computing devices 104 to send/receive information associated with users purchasing habits, merchant inventory, sales, special offers or the like that can be accessible in databases 108 and/or user computing devices 104, 106. Further, recommendation module 312 can be included that is configured to determine, generate and/or provide one or more recommendations associated with a particular user computing device 106 and/or product/service associated with merchant database(s) such as stored on storage/database devices 108. The recommendation(s) can be delivered to a respective merchant computing device 104 that is in close proximity (or other suitable relevance) to user computing device 106. Moreover, information, prompts and graphical screen controls can be provided, for example, on computing devices 104 and/or 106 via interface module 314.

In one or more implementations, the present application can include an application programming interface (“API”) module 316 that enables one or more software applications, for example, operating on user computing device 106 and/or a merchant computing device 104 and/or data processing apparatus 102. By providing an API in this way, developers can define and/or update information associated detecting and/or responding to consumer devices, as well as particular actions software applications operating on computing devices 102, 104, 106 and/or 108 take.

Custom defined audiences and/or individuals can be provided with a purchase recommendation or order can be instigated and provided to the user, for example, via a graphical user interface provided in a mobile computing device display screen configured in the user's automobile dashboard.

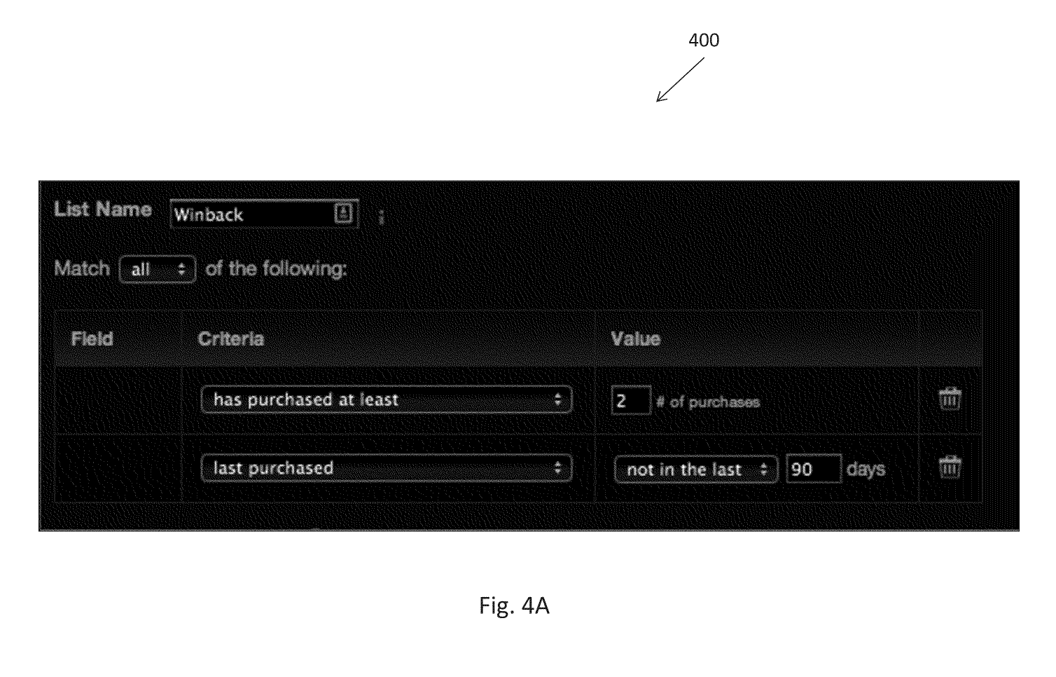

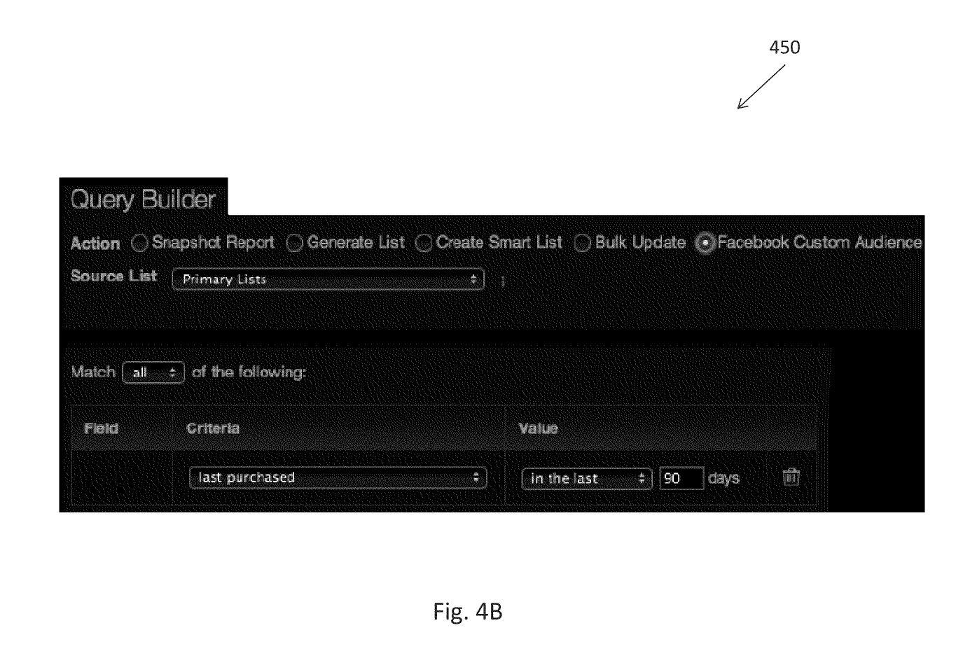

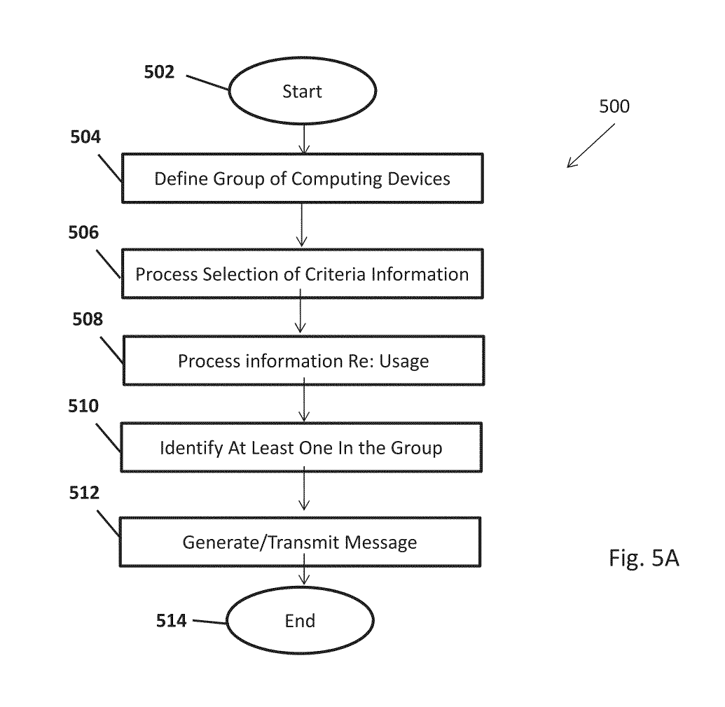

Criteria for submitting information to users, such as to make recommendations and/or place orders as shown and described herein, can be defined by authorized users, such as associated with a merchant. FIG. 4A is an example data entry display screen 400, which is usable to receive information from users to set one or more conditions associated with communications for product/service purchasing and to define a custom audience. In the example shown in display screen 400, members of a list name, “Winback” are to be selected for those who match criteria that include that a member of the list has not made at least two purchases of a respective product/service within the last ninety (90) days. Members of the Winback list that satisfy such criteria can be contacted, such as shown and/or described herein, with a suggestion and/or pre-purchase of a product/service.

Setting criteria, such as shown in connection with display screen 400, enables an ability to leverage a more complete view of a potential customer and would be otherwise possible. Groups of users can be targeted automatically, and relatively anonymously, when one or more conditions are met. Criteria for selecting users can be based on a variety of conditions, such as how the user prefers to browse the Internet (e.g., via a smartphone), whether a mobile app is installed on the user's mobile computing device.

In connection with defined target audiences, one or more email or other advertising campaigns can be defined in accordance with the present application. For example, a buyer “win-back” campaign can be provided for users who have purchased at least twice in the past, but have not engaged in known purchasing activity within a period of time, such as 90 days. In another example, a “missing-in-action” win back campaign can be provided to target people who have not opened a specific email message or visited a particular Internet website within a period of time, such as 30 days. One such example, a message may be provided that states “come back-we miss you!” In yet another example, an “activation discount” campaign can be provided for users who have been email subscribers for a particular amount of time, such as 30 or more days, but have not engaged in any purchasing activity. In yet another example, a “loyalist reward” campaign can be provided for users who have spent a minimum amount of money, such as $500, within a period of time, such as the previous year. Various other campaigns can be defined, such as shown in display screen 400, including campaigns associated with users who install an application on a mobile computing device, purchased a certain amount of product or service within a period of time, or for users who demonstrated interest in one or more products, such as indicated by website visits. Criteria for defining custom audience groups can be provided in a query builder or other graphical screen control, such as shown in FIG. 4A. Moreover, the present application supports cross marketing efforts, such as in connection with third-party social networks.

FIG. 4B is an example data entry display screen 450, which includes additional functionality for users to define a particular action (e.g., snapshot report, generate list, create smart list, bulk update and social network custom audience). In addition, functionality is provided for a user to define a list (e.g., “primary list”) which can be used as a reference for the target audience being defined.

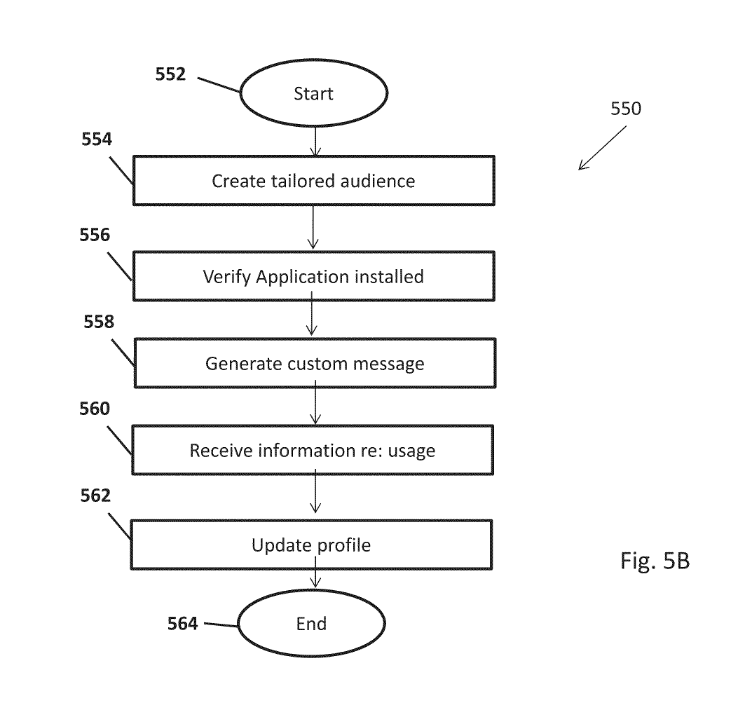

Turning now to FIGS. 5A and 5B, flow diagrams are described showing routines 500 and 550 that illustrate a broad aspect of a method for providing a targeted recommendation for a product or service in accordance with at least one implementation disclosed herein. It should be appreciated that several of the logical operations described herein are implemented (1) as a sequence of computer implemented acts or program modules running on computing device 102/104 and/or (2) as interconnected machine logic circuits or circuit modules within computing device 102/104/106. The implementation is a matter of choice and can be (though not necessarily) dependent on the requirements of the device (e.g., size, mobility, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

At step 502 (FIG. 5A), the process starts and at step 504 a group of computing devices is defined, such as in response to a selection made by a user in a graphical user interface (e.g., FIG. 4B). Thereafter, a selectin of criteria information representing a respective type of activity associated with users of the group of computing devices is processed (step 506). Usage information associated with each respective user is processed by comparing the usage information with the at least one criteria selection (step 508). In accordance with the processed usage information, the at least one of the computing devices in the group is identified (step 510), and a contextual message is generated and transmitted in accordance with at least one of the criteria selection (step 512). Thereafter, the process ends at step 514.

FIG. 5B is a flowchart showing example steps 550 in accordance with one or more implementations of the present application. At step 552, the process starts and at step 554 a tailored to audience is defined and generated, substantially as shown and described herein. At step 556, a verification is made that a mobile app is installed one or more user mobile computing devices, and a custom message is generated and displayed thereon (step 558). For example, in response to a verification that an app has been installed on a client device, and offer for a discount, coupon or other incentive is provided in the app for the user. At step 560, information regarding usage (e.g., product purchase, browsing or the like) is received and at step 562, the users profile information is updated therewith. Although the example steps shown and described in connection with FIG. 5B relate to whether a particular software application is installed, in other implementations various other conditions that are defined, such as in display screens 404 and 450, can be a basis for determining whether to generate a custom message in step 558.

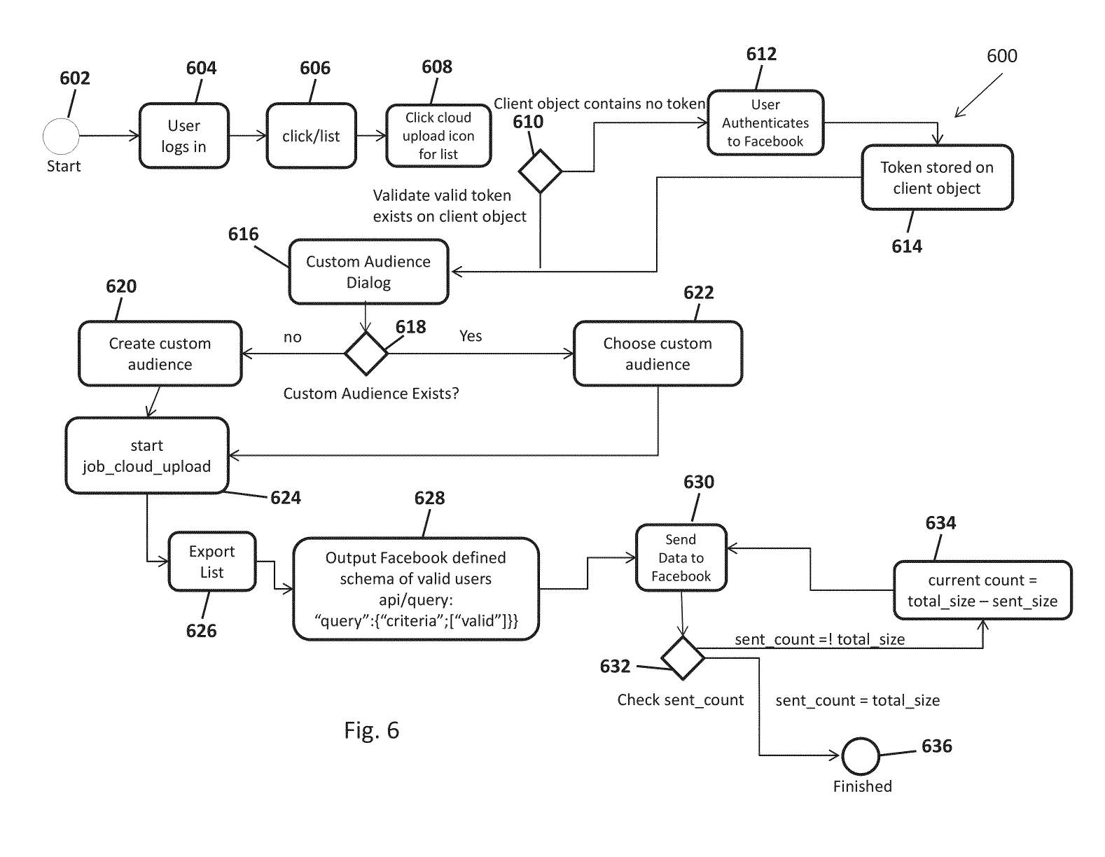

FIG. 6 is a flowchart illustrating steps 600 associated with an example implementation of the present application. In the example steps 600 shown in FIG. 6, the process starts at step 602 and, thereafter, a user logs in to access a data entry display screen, such as screen 450 shown in FIG. 4B (step 604), and the user selects (e.g., clicks) a list (step 606). In the implementation in steps 600, a further action is received from the user in step 608 for a cloud-based upload of the user list. Thereafter, in step 610, a determination is made whether a software application is installed that includes a valid token. If not, then the process branches to step 612 and the user authenticates on a social networking site, such as FACEBOOK. Thereafter, the token is provided vis-a-vis the social networking site and stored on the client device (step 614). If, in the alternative, the determination at step 610 is that a valid token exists on the client object, then the process branches to step 616 and a custom audience dialogue is provided for the user. Thereafter, a determination is made at step 618 whether a respective custom audience exists. If not, then the process branches to step 620 and options for defining a custom audience is provided. Alternatively, if a custom audience exists, then the process branches to step 622 and a selection is provided for the user to choose a custom audience. Thereafter, a process to upload information associated with a custom audiences is started (step 622), and a list of users is exported at step 626, a defined schema of valid users for respective social network site is output (step 628) and information associated therewith is transmitted to the social network site at step 630. Thereafter, the process continues to step 632 and a determination is made whether the transmission to the social network (e.g., “sent_count”) is accurate. If not, then the process branches to step 634 and a calculation is made to determine the information that did not get transmitted. The process then continues to step 630 until a determination is made that the entire transmission to the social network site is accurate, and the process ends at step 636.

In accordance with the teachings herein, it will be appreciated that many and various implementations of the present application can be applied to this technology. For example, personalized content can be provided as a function of a unique identifier included with the consumer's computing device and/or software application configuring the device. Alternatively, generic messaging is supported, such that every user of a computing device 106 is provided a similar generic message. As shown and described herein, user computing devices configured with one or more respective mobile apps can be leveraged to provide concise and direct amounts of information to users whom a particular party (e.g., a merchant) would like to reach.

Additionally, the present application can integrate an ordering system to the process, which eliminates the wait that often happens during travelling and stopping for food/beverages. Using location-aware devices, merchants can be made aware of a consumer's location, as well as an estimate of how long it will take for the consumer to arrive at the location. This streamlines ordering and improves efficiency. Also drivers can be made aware of potential delays (e.g., wait times), which can lead to better and more efficient decision making in the selection of an order and/or merchant. Furthermore, the present application can tie into a merchant's point of sale system, and information regarding predicted purchases that were made can be received from merchants, which contributes to the overall efficiency and accuracy of the present application.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for managing information for a group of computing devices associated with a plurality of users and providing contextual messages to at least one of the computing devices in the group, the method comprising:
defining, by code executing in at least one processor, the group of computing devices;
processing, by code executing in at least one processor, at least one criteria selection representing a respective type of activity associated with users of the group of computing devices;
processing, by code executing in the at least one processor, usage information associated with each respective user by comparing the usage information with the at least one criteria selection;
identifying, by code executing in the at least one processor and in accordance with the processed usage information, the at least one of the computing devices in the group;
generating, by code executing in the at least one processor, a contextual message in accordance with at least one of the criteria selection; and
transmitting, by code executing in the at least one processor, the contextual message to each of the at least one computing device in the group.

2. The method of claim 1, further comprising:
processing, by code executing in the at least one processor, usage information associated with a user that represents a response to the contextual message; and
updating a user profile stored in at least one database associated with the user.

3. The method of claim 1, further comprising:
providing, by code executing in a processor, a graphical user interface that is usable to receive information for defining the group of computing devices.

4. The method of claim 3, further comprising:
receiving, in the graphical user interface, the at least one criteria selection.

5. The method of claim 1, wherein the at least one computing device in the group is further identified as a function of a token installed on the at least one computing device.

6. The method of claim 1, further comprising:
transmitting, by code executing in a processor, a prompt to install a token in the at least one computing device in the group.

7. The method of claim 6, wherein the prompt is transmitted to a social network site that installs the token on the at least one computing device in the group.

8. The method of claim 1, wherein the at least one criteria selection includes at least one of purchasing history and browsing history.

9. The method of claim 1, wherein the contextual message is an advertisement and/or a coupon.

10. A system for managing information for a group of computing devices associated with a plurality of users and providing contextual messages to at least one of the computing devices in the group, the system comprising:
non-transitory processor readable media;
at least one processor operatively coupled to the at least one processor readable media;
the non-transitory processor readable media having instructions for causing the following steps to be performed by the at least one processor:
defining the group of computing devices;
processing at least one criteria selection representing a respective type of activity associated with users of the group of computing devices;
processing usage information associated with each respective user by comparing the usage information with the at least one criteria selection;
identifying in accordance with the processed usage information, the at least one of the computing devices in the group;
generating a contextual message in accordance with at least one of the criteria selection; and
transmitting, by code executing in the at least one processor, the contextual message to each of the at least one computing device in the group.

11. The system of claim 10, wherein the non-transitory processor readable media further have instructions for causing the following steps to be performed by the at least one processor:
processing usage information associated with a user that represents a response to the contextual message; and
updating a user profile stored in at least one database associated with the user.

12. The system of claim 10, wherein the non-transitory processor readable media further have instructions for causing the following steps to be performed by the at least one processor:
providing a graphical user interface that is usable to receive information for defining the group of computing devices.

13. The system of claim 12, wherein the non-transitory processor readable media further have instructions for causing the following steps to be performed by the at least one processor:
receiving, in the graphical user interface, the at least one criteria selection.

14. The system of claim 10, wherein the at least one computing device in the group is further identified as a function of a token installed on the at least one computing device.

15. The system of claim 10 , wherein the non-transitory processor readable media further have instructions for causing the following steps to be performed by the at least one processor:
transmitting a prompt to install a token in the at least one computing device in the group.

16. The system of claim 15, wherein the prompt is transmitted to a social network site that installs the token on the at least one computing device in the group.

17. The system of claim 10, wherein the at least one criteria selection includes at least one of purchasing history and browsing history.

18. The system of claim 10, wherein the contextual message is an advertisement and/or a coupon.
